(19) United States
(12) Patent Application Publication
(10) Pub. No.: US 2004/0034548 A1
(43) Pub. Date: Feb. 19, 2004

(54) Apparatus and method of implementing an internet radio community health support system

(76) Inventors: Yohaness Teklu, Camp Springs, MD (US); Ronald S. Karpf, Gaithersburg, MD (US)

Correspondence Address: DICKSTEIN SHAPIRO MORIN & OSHINSKY LLP, 2101 L STREET NW, WASHINGTON, DC, 20037-1526, US

(21) Appl. No.: 10/638,490

(22) Filed: Aug. 12, 2003

Related U.S. Application Data
(60) Provisional application No. 60/404,148, filed on Aug. 19, 2002.

(51) Int. Cl. G06F 17/60

(52) U.S. Cl. 705/2

(57) ABSTRACT

In accordance with a preferred embodiment of the invention, posting a health message to the community is simple for health sponsors since all they need is a phone—no Internet access is required. Since health messages can be posted quickly, the system can support a community's need for timely information even about local health emergencies. For users, audio messages, that have a simple linear organization from start-to-finish, are preferable to printed messages. Even users with slow dial-up modem access to the Internet can easily listen to the audio health messages. While the Web is a worldwide resource, embodiments of the invention serve a ‘community’ of users with like interest by providing health information useful to the community. Since dissemination of timely health information is beneficial to the community, use of embodiments of the invention in the form of a Community Health Support system by Health Sponsors and community members reinforces the value of the system to the community.

This application claims the benefit of U.S. Provisional Application No. 60/404,148 filed Aug. 19, 2002, which is hereby incorporated by reference herein in its entirety.

### BACKGROUND OF THE INVENTION

The myriad of the health programs available to help address the nations health problems are often too confusing for citizens and communities to comprehend. Programs such as Medicare for the elderly, Medicaid for the economically disadvantaged have benefits that are underutilized by individuals and communities because information about them, presented as brochures or instructions manuals, are difficult to acquire and hard to read and understand.

Federal, state, and local government programs that address the health problems of medically underserved populations with programs such as inoculations, health screening, lifestyle training, etc., often have only limited notice to the communities. For instance, free inoculation programs for childhood diseases may miss large numbers of unprotected children due to improper community preparation and notification. Similarly, communities are often unaware of the time and place of blood drives. Part of the problem is that economically and medically disadvantaged communities are without sufficient infrastructure to inform, advise, and educate residents about community health programs. Better and more reliable community infrastructure would increase residents participation with concomitant benefit to their health.

Some community messages need instantaneous broadcast and there is not sufficient time to prepare printed materials. This may occur during an event such as a bio-terror attack when health messaging to communities in proximity to the attack are of time critical nature and have to be available to the entire community. Similar situations arise with hazardous toxic substance spills and tornados. While TV and radio could be utilized in such a circumstance, they are bandwidth-limited resources, and cannot be dedicated to just a single message.

### BRIEF SUMMARY OF THE INVENTION

In accordance with a preferred embodiment of the invention, posting a health message to the community is simple for health sponsors since all they need is a phone no Internet access is required. Since health messages can be posted quickly, the system can support a community's need for timely information even about local health emergencies. For users, audio messages, that have a simple linear organization from start-to-finish, are preferable to printed messages. Even users with slow dial-up modem access to the Internet can easily listen to the audio health messages. While the Web is a worldwide resource, embodiments of the invention serve a ‘community’ of users with like interest by providing health information useful to the community. Since dissemination of timely health information is beneficial to the community, use of embodiments of the invention in the form of a Community Health Support system by Health Sponsors and community members reinforces the value of the system to the community.

In a preferred embodiment, the Internet Radio Community Health Support system has a phone number that is used by health sponsors to post messages to the Community Health Support system. The phone number is provided to health sponsors, such as the local government Department of Health, or private non-profit health organizations serving the community, such as the American Red Cross. For rudimentary identification and authentication purposes, Health Sponsors provide the phone number from which they will phone in their messages. The health sponsor calls in to the phone number from their designated number, and records a health message for distribution to the local community. The associated caller-id number is also stored. The caller-id is used to identify the source of the message, and authenticates that the Health Sponsor has been certified by the Community Health Support system administrator to post audio health messages. Recording the message is similar to, and as simple as leaving a message on a phone answering machine. Health messages from authenticated health sponsors are processed and converted to a streaming format for broadcasting, and then stored as a digital audio file on the Internet Radio Community Health Support System, scheduled for broadcast, posted in an online program schedule, and listed in an online archive for on-demand retrieval. Community-based users listen to the broadcast health messages, or can listen to the messages at any time from an on-demand web-based archive.

Other embodiments of the invention provide more control over the posting of messages, broadcast scheduling, broadcast program schedule, and health message archive listing. In these other embodiments the posting of health messages to the system is limited by the administrators of the Health Support Community system either through authentication means and/or by moderating the recorded messages. The sponsors are provided means to select and specify the broadcast time for their messages that will not interfere with already scheduled broadcasts. The sponsors may also be provided with means to provide a title and narrative description of the health message for inclusion in an online program schedule, as well as means to categorize the type of message. Listeners may have access to a dynamically system generated web-based program schedule, that displays the title and narrative description, and displays programs sorted according to category type.

In an exemplary application of the invention, the Health Support system is commandeered for support of the community in an emergency. All scheduled broadcasts are cancelled and only the emergency information is broadcast repetitively. In cases of hazardous substances spills, bio-terror attack, tornado warnings, etc., the Health Support system could allow only endless-loop playing of appropriate emergency messages until the termination of the emergency. Since there are no bandwidth limitations to the Health Support system, the message is ‘always-on’ and available to the residents immediately.

An embodiment of the invention has a “phone-in, digital audio-out” communication structure, and can be roughly described as an audio listserve. The Community Health Support system, users ‘pull’ the audio message by listening to the broadcast or requesting an archived audio file.

Audio messages are an ‘eyes free’ medium, inherently more understandable and for many people are the preferred means of communication. The system allows health program sponsors the easiest possible means to announce their programs to the community. The system can effectively target messages that are of interest to small groups such as a community, or large groups such as Medicaid recipients.

### BRIEF DESCRIPTION OF THE DRAWINGS

Many advantages, features, and applications of the invention will be apparent from the following detailed description of the invention that is provided in accordance with the accompanying drawings in which:

FIG. 1 is a block diagram describing a preferred embodiment of the invention showing the Internet Radio Community Health Support System.

FIG. 2 is a block diagram of a preferred embodiment of the Internet Radio Community Health Support Server.

FIG. 3 is a flow chart showing the operation of the in-processing module of a preferred embodiment of the Internet Radio Community Health Support Server.

### DETAILED DESCRIPTION OF THE INVENTION

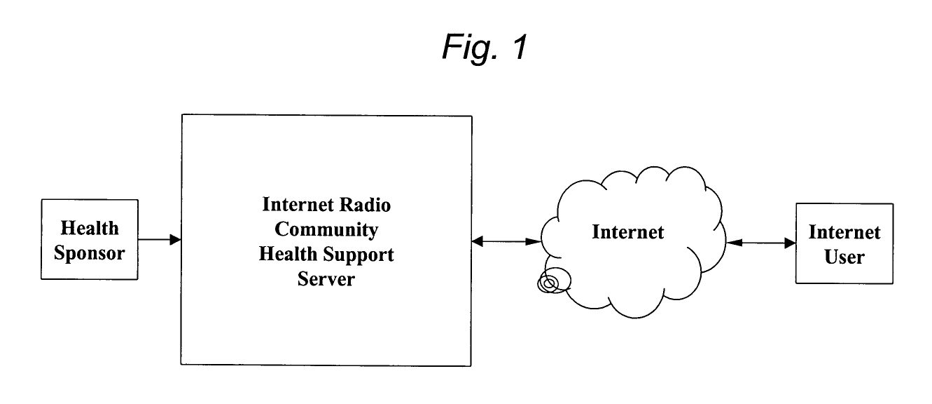

Preferred embodiments and applications of the invention will now be described with reference to FIGS. 1-3. Other embodiments may be realized and structural or logical changes may be made to the disclosed embodiments without departing from the spirit or scope of the invention. Although embodiments of the invention are particularly described or applied to providing an Internet Radio Community Health Support System for the purpose of promoting health matters, it should be readily apparent that the invention may be embodied for other matters having the same or similar problems. It is also readily apparent that for the purposes of the invention the community may be more than a geographically proximate area, but may be any ‘community’ of people with a common interest. (U.S. Pat. Nos. 5,793,980; 5,917,835; and 6,249,810 are hereby incorporated by reference in their entireties.)

Internet radio is a rapidly growing format that can be utilized for education and information dissemination that has significant advantages over broadcast radio. It builds on the information and entertainment medium of radio—an exclusively ‘eyes free’ aural skill that is truly worldwide and usable by rich/poor, educated/uneducated, young and old. Unlike the World Wide Web (Web), that is primarily an interactive visual medium, Internet Radio utilizes audio communication skills. Audio information can achieve educational results unattainable by visual means. Internet radio can be scheduled for timely broadcast to a local community or worldwide audiences, or archived for on-demand access. Broadband Internet access is not necessary, as the limited bandwidth requirements make it accessible to anyone even with a dial-up or wireless modem, and listeners can select options, such as language. While traditional radio is bandwidth limited by frequency allocation of the radio spectrum, the Internet has no such limitation and unlimited numbers of Internet Radio channels can serve any grouping of individuals.

In a preferred embodiment, a community health support system apparatus (and corresponding method) is embodied in an Internet Radio Community Health Support System, as illustrated in FIG. 1. In FIG. 1, the Internet Radio Community Health Support Server provides the means to record audio messages by the Health Sponsors, and for Internet Users to access the messages over the Internet. Health Sponsors phone into the Internet Radio Community Health Support Server to record their messages and the Internet Users utilize their Internet connection to listen to Health messages.

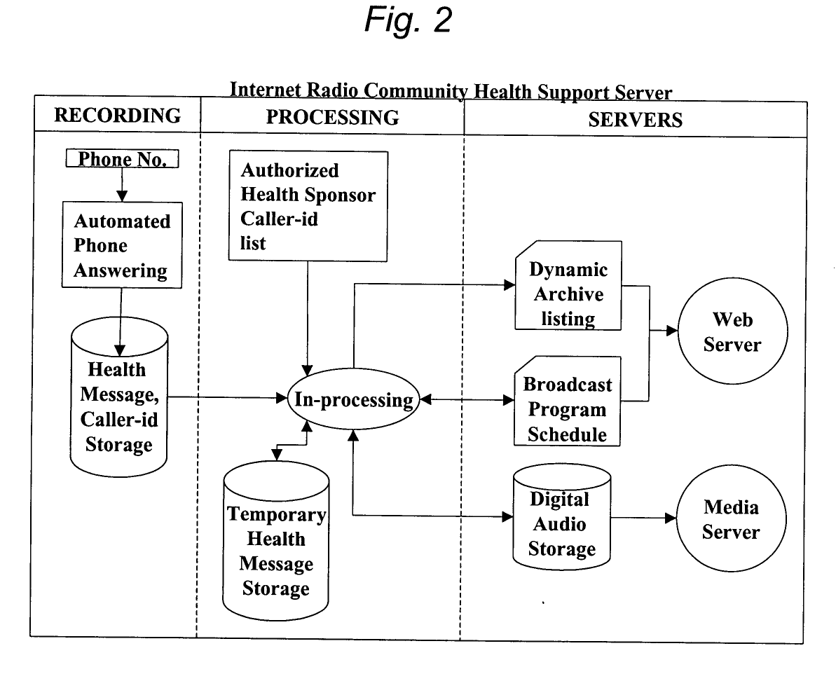

As shown in FIG. 2, in accordance with a preferred embodiment of the invention, an Internet Radio Community Health Support server may be provided and may be viewed as 3 distinct parts or modules: RECORDING, PROCESSING, and SERVERS. The RECORDING part allows the Health Sponsors to phone in and record their messages. PROCESSING provides authentication for the health messages and semi-automated processing of the audio messages to a streaming digital format, and posting of the audio messages, online program schedule, and an online archive, to the media and web servers that respond to requests from Internet users for health messages. PROCESSING also provides a means for the administrator of the system to maintain and update the list of authorized caller-id phone numbers and their associated health sponsors. This list is utilized by PROCESSING to authenticate health messages phoned into the system. SERVERS respond to users requests for information about the schedule of health messages, broadcast health messages according to the schedule, and stream health messages to users from the online health message archive.

RECORDING encompasses all functions necessary for the Health Sponsor to phone in health messages and record the health messages. In a preferred embodiment this is performed using a telephone answering machine-type function that records messages digitally and can also store the caller-id of the person who recorded the message. Caller-id is the phone number from which the Health Sponsor called in the health message.

The Health Sponsor calls the Phone No associated with the Community Health Support system and records its messages. The message and Caller-id are stored digitally on the recording device.

In a preferred embodiment, a single phone number is used by all Health Sponsors to record health messages. In other embodiments, there may be more than one phone number that Health Sponsors can use to phone-in health messages. In a preferred embodiment, a digital recorder may be used while in other embodiments an analog tape recorder can be used. In other embodiments, the phone set and telephone answering machine may be replaced by computer telephony that uses a computer to receive and record calls.

PROCESSING

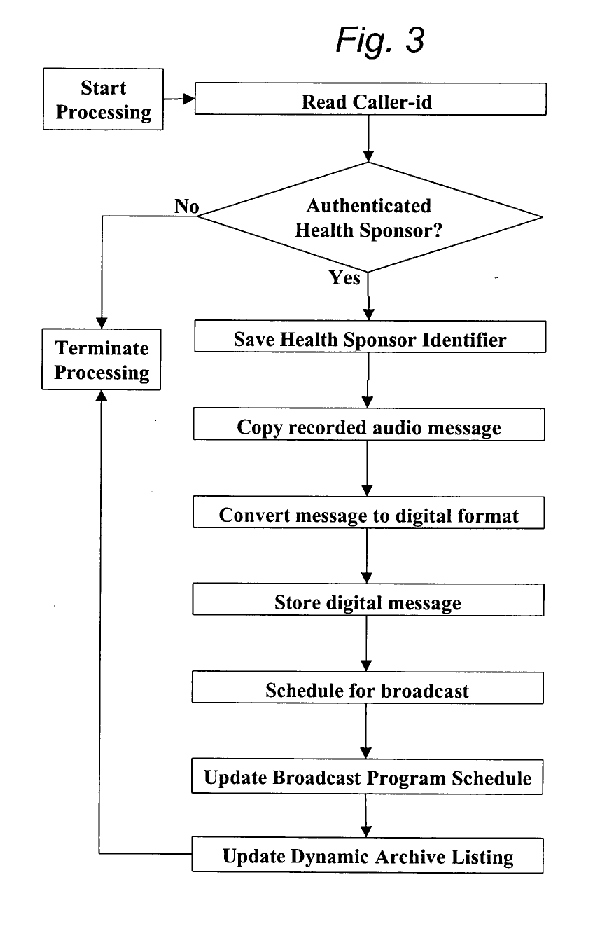

When a new health message has been received the In-processing procedure is initiated to authenticate and identify the Health Sponsor of the health message and to prepare the health message for broadcast and access by Internet Users. More details of the In-Processing module are provided in FIG. 3.

Authentication and identification proceeds by checking the recorded caller-id of the message against the Authorized Health Sponsor Caller-id list. If the caller-id is in the list then the Name associated with the caller-id identifies the Health Sponsor and the Health message will be posted on the Community Health Support System for broadcast and on-demand access.

In a preferred embodiment, the Authorized Health Sponsor Caller-id list is implemented as a text file stored on the PROCESSING computer. Each line or record of the file contains an entry for a Health Sponsor that includes their name, and the phone (caller-id) number that they will use to call in the phone number. The unique entry in each record is the phone number. There may be multiple entries for the same Health Sponsor if multiple and distinct phone numbers are used by the Health Sponsor to phone in health messages. The administrator of the Community Health Support system maintains the list using a text editor operating on the PROCESSING computer, and can insert, delete or edit entries in the text file. In other embodiments, the Authorized Health Sponsor Caller-id list is implemented in a database applications package, such as ORACLE RDBMS, or Microsoft Access. In this case the Authorized Health Sponsor Caller-id list would be implemented and maintained in a database table with fields for Name and phone number of the Health Sponsor, and with the phone number field the primary key for the table.

Preparation of the health message for broadcast and access by Internet Users includes converting and storing the health message as a streaming audio file, and generating and storing the Dynamic Archive Listing and Digital Broadcast Program Schedule. The stored message is converted to a streaming format and stored on the Digital Audio Storage. As part of the conversion process the administrator will listen to the health message and generate a Name to identify the health message and a single paragraph Narrative Description of the health message.

The Dynamic Archive Listing is an up-to-date listing of all messages in the Digital Audio Storage that are accessible on-demand. In a preferred embodiment, the Dynamic Archive Listing is alphabetical by name of the Health Sponsor, and within that major categorization organized by date and time using the date stamp from the associated digital audio file stored in the Digital Audio Storage. Whenever the Inprocessing module is performed, the Dynamic Archive Listing is regenerated and stored by reading the Dynamic Archive Listing and adding a link to the associated streaming audio file. The link to the associated file stored in the Digital Audio Storage, displays the date stamp of the associated digital file stored in the Digital Audio Storage, Name and Narrative Description of the health message.

The Broadcast Program Schedule provides a listing of the broadcast date/time for each health message that is scheduled for broadcast. In a preferred embodiment, the Broadcast Program Schedule is organized in a calendar format by time, date, month, and year. In other embodiments, the Broadcast Program Schedule may have other formats, such as alphabetical by Health Sponsor. Whenever the In-processing module is performed, the Broadcast Program Schedule is regenerated and stored by reading the current Program Schedule and adding the new health message to the entry at each date/time it is scheduled for broadcast. Each health message entry includes the date stamp of the associated digital file stored in the Digital Audio Storage, Name and Narrative Description of the health message. If scheduling conflicts occur between the old and new health messages, this may also require updating the broadcast date/time of other health messages.

SERVERS

SERVER functions are dedicated to responding to requests from users for Community Health Information. The Media Server broadcasts scheduled health messages 24×7 (twenty-four hours a day and 7 days a week) that are stored in the Digital Audio Storage. This utilizes a multicast Internet multicast protocol in which the Media Server broadcasts over the internet to a range of IP addresses/stations without regard to whether the target stations are listening or receiving the broadcast messages. To listen to the broadcasting Community Health Support station, the user types the URL of the station into their web browser or media player, and their player will play the Community Health Support radio. In circumstances where a community can be delimited by a range of IP addresses, such as in the network serving a college community, the Media Server would be restricted to broadcasting only to that range of IP addresses.

To play a health message in the archive, the user accesses the Archive Listing over the Internet. The Web server responds to the request for the Archive Listing by sending it to the User. The User views the archive, including the Name and Narrative Description of the health message, and points-and-clicks at the hypertext link for a health message, which then connects to the Media Server. The Media Server responds by streaming the requested file stored in the Digital Audio Storage to the User. In this case a unicast streaming protocol is used, which is a point-to-point connection between the user and Media Server.

To check the time at which a health message will be broadcast, the User accesses the Broadcast Program Schedule over the Internet. Each item in the Broadcast Program Schedule includes the Name and Narrative Description of the health message. The Web Server responds to the request by retrieving the Broadcast Program Schedule and sending it to the User.

In a preferred embodiment, the Media Server is implemented using the Microsoft Media Server which multicasts (broadcasts) and unicasts (on-demand) Internet Radio files located in the Digital Audio Storage using the mms protocol. The Web Server is implemented using the Microsoft IIS 5.0 Web server which responds to requests for the archive listing and broadcast program schedule using the html language (Hyper Text Markup Language) over http protocol (Hyper Text Transport Protocol).

In a preferred embodiment, the MP3 format (MPEG-1, Layer III; Motion Picture Expert Group) is used for the digital audio streaming format of the health messages. It is used since it is a compressed format with good audio quality for both conversation and music, can be streamed by the Media Server, and is accessible to users with any type of equipment—either IBM or Apple PCs running Microsoft's Windows Media Player (WMP), RealNetworks' RealPlayer or Apple's Player. In other embodiments, other streaming audio formats may be used.

In a preferred embodiment, each of the PROCESSING, Web Server, and Media Server are implemented on distinct computers, each with their own CPU, bus, disk storage, RAM, monitor, keyboard, and mouse. Other hardware configurations may alternatively be used. For instance, the Media Server and Web Server could operate on a single computer, or PROCESSING, Web Server, and Media Server could all share a single computer.

In a preferred embodiment, the Community Health Support System administrator manually maintains the radio program and archive message listings to remove expired programs. For instance, a health message about an inoculation is no longer useful to a community after the date of the inoculation. The message about the inoculation is removed from the system by having the administrator manually delete the files from the Digital Audio Storage, and remove the references to the inoculation from the Dynamic Archive Listing, and the Broadcast Program Schedule by editing and replacing the associated html files. In other embodiments, these functions may be automated by providing an expiration date/time for each message at the time of creation in the In-processing module of PROCESSING. The maintenance for expired messages would then be an automated function performed by the In-processing module of PROCESSING.

FIG. 3 is a flow chart describing the operation of the In-processing module of a preferred embodiment of the Internet Radio Community Health Support Server. In a preferred embodiment, In-processing is a combination of manual steps and computer application steps performed on the PROCESSING computer. The first step of the processing of a new health message, is to read the associated Caller-id number of the health message that is to be posted to the Community Health Support server. The Caller-id number is checked against a listing of the Authorized Health Sponsor Caller-id list. If the caller-id number is in the listing then the Health Sponsor is authenticated and the message can be posted and the Health Sponsor Identifier saved. If the caller-id number is not in the listing then the health message will not be posted and the Inprocessing is terminated without posting the message to the Community Health Support server.

If the Health Sponsor of the message is authenticated then the next step is to Copy the recorded message to a digital file on the PROCESSING computer. This is accomplished by using an audio cable attached to the line-out connector of the audio recorder and the line-in connector of the PROCESSING computer. The message is then played on the recorder and recorded by the PROCESSING computer. In a preferred embodiment, the Macromedia SoundEdit 16 software is used on the PROCESSING computer to capture and copy the health message. The file is saved on the PROCESSING computer in a non-compressed format such as WAV that is amenable to sound editing. It is stored in the Temporary Health Message Storage on a mass storage device such as a computer disk.

In the next step the audio is processed. The administrator listens to the file and generates a Name and Narrative Description of the health message that is saved. The audio application software Macromedia SoundEdit 16 is used for basic sound editing consisting of tasks such as removal of audio artifacts, smoothing of silences and pauses, spike analysis, equalization of frequencies and amplitude reduction. The SoundEdit 16 application software is started and the health message read from the Temporary Health Message storage. The basic sound editing may be started and stopped with successively edited files stored and restored in the Temporary Health Message Storage. The final edited file is then converted to the streaming digital format MP3 using SoundEdit 16, and stored on the Digital Audio Storage of the Media Server. In other embodiments, other sound editing applications packages such as Windows Media Encoder application packaged may be utilized to edit, convert and store the health message audio files.

The health message is now ready to be scheduled for broadcast. In a preferred embodiment, broadcast scheduling is handled by the Media Server. The administrator determines the date(s) and time(s) that the message will be broadcast and enters the information through the console of the Media Server. Whenever the Media Server is operational, the new message will be broadcast at the appointed date(s) and time(s).

The next step is to update the Broadcast Program Schedule that is maintained on the Web Server as an html file. In a preferred embodiment, the Broadcast Program Schedule html file is read using the Windows HTML editor. The Name, Narrative Description, Health Sponsor, and date/time that the file was posted to the Digital Audio Storage are edited into the Broadcast Program Schedule for every date/time the health message will be broadcast. The Broadcast Program Schedule html file is then restored on the Web Server.

The last step is to update the Dynamic Archive Listing that is maintained on the Web Server as an html file. In a preferred embodiment, the Dynamic Archive Listing html file is read using the Windows HTML editor. The Name, Narrative Description, Health Sponsor, and date/time that the file was posted to the Digital Audio Storage are edited into the listing. The Name is hyperlinked to the digital audio file in the Media Server Digital Audio Storage so the user may initiate the playing of the health message from the archive by pointing-and-clicking on the hyperlink. The Dynamic Archive Listing html file is the restored on the Web Server. In-processing is then terminated.

In an alternative embodiment of the invention, the Health Sponsor provides the Name and Descriptive Narrative for the health message - the administrator of the Community Health Support System performs this function in a preferred embodiment. In one alternative embodiment the Health Sponsor records the Descriptive Name and Descriptive Narrative along with the phone message recording of the health message. The Descriptive Name and Descriptive Narrative are transcribed by the administrator, and eliminated from the health message recording during the editing step. The Name and Descriptive Narrative are used by the administrator during the In-processing procedure to update the Broadcast Program Schedule and the Dynamic Archive Listing.

In another alternative embodiment of the invention, the Health Sponsor takes over the responsibility for scheduling the health message from the administrator. Prior to recording the message, the Health Sponsor checks the online Broadcast Program Schedule and selects air time that is not presently in use. As part of the process of recording the health message, the Health Sponsor also records the time(s) at which the health message is to be broadcast. The scheduling times are transcribed by the administrator, and eliminated from the health message recording during the editing step. The scheduling time(s) is used by the administrator during the In-processing procedure to schedule the health message for broadcast.

Other Embodiments

In other embodiments, the Community Health Support System may use Access Control Lists to authenticate Users attempting to listen to health messages. Access Control Lists are usually implemented using Username/Password lists. The Access Control List may be implemented to allow Users access to all or only a subset of audio health messages.

In emergency situations, the Community Health Support system is commandeered for support of the community. In this application, a single message may be replayed in an endless loop until the emergency ends. All non-emergency messages are cancelled. If more than one message is appropriate for the emergency, the messages are scheduled one after another for continuous play. In such situations, the Community Health Support Systems administrator appropriately edits the Broadcast Program Schedule and Dynamic Archive Listing, and edits the Broadcast schedule for the Media Server.

In another embodiment, the Health Sponsor or administrator categorize the health messages by keywords. An advanced functionality Community Health Support System allows users to search or sort health messages in the Broadcast Program Schedule and/or Dynamic Archive Listing to better locate the health messages they are interested in.

In other embodiments, the system may support a community's information needs in matters other than health. For instance, residents of underserved communities are often unaware of the myriad of support programs, such as employment training, offered by local, state, and federal government. A Community Support System could provide such information via audio means, customized and targeted to local communities. Also, the community need not be defined by geography but can be any group of users defined by a common matter. For instance, cardiologists have a common need for timely updated information about therapeutic drugs that they prescribe to their patients for treating coronary heart disease. A Cardiologist Support System could provide health alerts to cardiologists via audio means. A Support System would work equally well to allow a church minister to post audio messages to the Internet for the community defined by the church congregation.

In another embodiment, the Community Support system may support several communities. For instance, Gaithersburg and Rockville Maryland are adjoining communities that can share many of the same services. Rather than separate systems for each community, it may be more efficient to have a single Community Support system serving several neighborhoods. Inoculations by the County Department of Health would be setup to serve both communities as an example. In some cases then it would be beneficial to have support messages broadcast or posted for on-demand access to both communities, while at the same time there is also a need for support messages just for the community. These demands would be met by (1) having distinct broadcast streams for each community, and another for both communities (2) allowing multiple entries for a date/time range in the broadcast schedule to reflect this multiplicity of broadcast streams, (3) providing archives with all recorded streams clearly distinguishing their target community or communities, and (4) providing a means for the Health Providers to record a message and indicate which is the target community or communities.

The computer programs or algorithms described herein may easily be configured as one or more hardware modules, and the hardware modules shown may easily be configured as one or more software modules without departing from the invention.

### EXAMPLE

While preferred embodiments of the invention have been described and illustrated, it should be apparent that many modifications to the embodiments and implementations of the invention can be made without departing from the spirit or scope of the invention. For example, although specific illustrations provided herein may have made reference to the use of the Internet, it should be readily apparent that any network or other wired/wireless connective technology (e.g., corporate or individual LAN, enterprise WAN, intranet, Virtual Private Network (VPN), combinations of network systems, PCI (or other internal computer) bus etc.) to allow a server to provide local/remote information and control data to/from other locations (e.g., user, etc.). In addition, although specific embodiments have described the use of telephony and other technology to relay and record sponsor messages, it should be readily apparent that the Health Support system can be implemented to receive sponsor messages in any form (e.g., digital, analog, text, etc.) to be directly broadcast (or transformed into another format before being broadcast) to users.

While a client-server architecture has been specifically illustrated herein, the invention may easily be deployed in any form of network or other communication technology, as well as in the form of a stand-alone computer system (e.g., desktop, laptop, etc.). While the illustrated embodiments have not specified the type of communication medium (or protocol) used to connect the various modules, it should be apparent that any known wired/wireless technology may be used to implement the invention (e.g., PCI bus, firewire, USB, Internet, intranets, private bulletin boards, individual local or wide area networks, proprietary chat rooms, ICQ, IRC channels, instant messaging systems, WAP, bluetooth, Fibre Channel, etc.) using real-time or non-real-time systems alone or in combination. The embodiments described in (or apparent from) the instant disclosure may be employed in stand-alone (or network linked) systems. The embodiments may similarly be implemented in other known systems and platforms (e.g., personal computer, Internetbased devices, PDAs, portable or hand-held electronic devices, etc.).

In accordance with a preferred embodiment, one or more user interfaces are provided as part of (or in conjunction with) the illustrated systems to permit users to interact with the systems. User interface devices may be any device used to input and/or output information. The user interface device may be implemented as a graphical user interface (GUI) containing a display or the like, or may be a link to other user input/output devices known in the art. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described. The illustrated embodiments have further been described in connection with one or more “users.” It should be readily apparent that a “user” of the various aspects of the inventive systems or methods disclosed or apparent herein may be individuals, entities, devices, as well as peer/non-peer systems or technologies, and modules within the same device or system without departing from the scope of the invention.

The modules described herein, particularly those illustrated or inherent in the instant disclosure, may be one or more hardware, software, or hybrid components residing in (or distributed among) one or more local or remote computer systems. Although the modules may be shown or described herein as physically separated components, it should be readily apparent that the modules as described herein are merely logical constructs that are implemented as physical devices that may be omitted, combined or further separated into a variety of different components, sharing different resources (including processing units, memory, clock devices, software routines, etc.) as required for the particular implementation of the embodiments disclosed (or apparent from the teachings herein). Indeed, even a single general purpose computer (or other processor-controlled device) executing a program stored on an article of manufacture (e.g., recording medium (e.g., CD-ROM) or other memory units) to produce the functionality referred to herein may be utilized to implement the illustrated embodiments.

In addition, memory, storage or database units described (or apparent from the disclosure) herein may be logical or physical constructs and may be any one or more of the known storage devices or systems (e.g., Random Access Memory (RAM), Read Only Memory (ROM), hard disk drive (HDD), floppy drive, zip drive, compact disk-ROM, DVD-ROM, bubble memory, redundant array of independent disks (RAID), network accessible storage (NAS) systems, etc.), may also be one or more memory devices embedded within a CPU, or shared with one or more of the other components, and may be deployed locally or remotely relative to one or more components interacting with the memory, storage or database units.

For simplicity, preferred embodiments of the invention have been described herein primarily in terms of implementations in the form of an apparatus. It should be readily apparent, however, that the preferred embodiments may be similarly implemented in the form of a method of performing the operations specifically described (or apparent from) the disclosures made herein. The method or process disclosed (or apparent) herein may easily be modified to include additional steps, omit one or more steps, utilize different orders of steps, and combine one or more steps without departing from the invention. The method steps may be reduced to practice manually, by an apparatus, or by any combination of manual and apparatus implementations.

Accordingly, the invention is not to be limited by the foregoing description or drawings, but only by the claims appended hereto.

What is claimed as new and desired to be protected by Letters Patent of the United States is:

1. An Internet Radio Health Support System comprising:
a recording portion, wherein said recording portion receives and records health messages provided by a health sponsor;
a processing portion, wherein said processing portion authenticates the health sponsor providing the health message, preparing the health message from broadcast; and
a server portion, wherein said server portion broadcasts health messages as scheduled for broadcast.

2. The Internet Radio Health Support System as recited in claim 1, wherein said recording portion receives a telephone call from the health sponsor and digitally records the health message as an audio recording.

3. The Internet Radio Health Support System as recited in claim 1, wherein said processing portion comprises a list of authorized health sponsors.

4. The Internet Radio Health Support System as recited in claim 3, wherein the list of authorized health sponsors includes caller-ID numbers uniquely associated with authorized health sponsors

5. The Internet Radio Health Support System as recited in claim 1, wherein said processing portion comprises a digital audio storage for storing the health message as a streaming audio file.

6. The Internet Radio Health Support System as recited in claim 5, wherein said processing portion further comprises a dynamic archive listing containing all of the messages stored in the digital audio storage;

7. The Internet Radio Health Support System as recited in claim 5, wherein said processing portion further comprises a broadcast program schedule providing a broadcast time in which each health message is to be broadcast;

8. The Internet Radio Health Support System as recited in claim 1, wherein said server broadcasts health messages over the Internet utilizing a multicast Internet protocol;

9. The Internet Radio Health Support System as recited in claim 1, wherein said server broadcasts health messages by streaming or given health message utilizing a unicast streaming protocol in a point-to-point connection with a user requesting the given health message.

10. A method of issuing a health message, the method comprising the steps of:
designating a telephone number uniquely associated with a health sponsor;
receiving a telephone call from the health sponsor;
utilizing a caller-ID telephone number associated with the received telephone call;
authenticating the health sponsor by comparing the caller-ID with the designated telephone number associated with the health sponsor;
permitting the health sponsor to post a health message, wherein the health sponsor posts a health message by providing an audio health message;
converting the health message onto a format for broadcasting;
scheduling a time to broadcast the health message; and
broadcasting the health message over the Internet as an Internet radio signal at the scheduled time.

11. The method of issuing a health message as recited in claim 10, wherein said permitting step includes the step of limiting the posting of a health message by moderating the posts of health messages.

12. The method of issuing a health message as recited in claim 10, wherein said scheduling step includes the step of allowing the health sponsor to specify a time to broadcast the health message.

13. The method of issuing a health message as recited in claim 11, wherein said permitting step further comprises the step of allowing the health sponsor to provide a title and narrative description of the health message.

14. The method of issuing a health message as recited in claim 10, wherein in an emergency operation mode said step of broadcasting health messages is suspended to allow continuous broadcast of an emergency message.
